(19) United States
(12) Patent Application Publication
(10) Pub. No.: US 2011/0100739 A1
(43) Pub. Date: May 5, 2011

(54) CONTROL SYSTEM FOR A HYBRID PROPULSION UNIT FOR RECHARGING A BATTERY

(75) Inventors: Philippe Pognant-Gros, Rueil-Malmaison (FR); Olivier Reyss, Paris (FR); Arnaud Villeneuve, Vernouillet (FR)

(73) Assignee: RENAULT S.A.S., BOULOGNE-BILLANCOURT (FR)

(21) Appl. No.: 12/597,345

(22) PCT Filed: Apr. 3, 2008
(86) PCT No.: PCT/FR08/50585

§ 371 Date: Jan. 19, 2011

(30) Foreign Application Priority Data
Apr. 23, 2007 (FR) 0754632

(51) Int. Cl. B60W 20/00; B60W 10/08; B60K 6/543; B60K 6/22; B60W 10/18; B60W 10/06

(52) U.S. Cl. 180/65.265; 903/903; 903/918

(57) ABSTRACT

A control system for a hybrid propulsion group with power bypass for an automobile including at least two driving wheels. The system includes a thermal engine, a battery, a braking system for the driving wheels, a mechanism detecting a condition of the braking system, and an infinitely variable transmission including at least two electric machines and at least two epicyclic gear chains. The thermal engine is mechanically connected with the infinitely variable transmission via a first epicyclic gear chain, the infinitely variable transmission being mechanically connected to the driving wheels via a second epicyclic gear chain. The control system is capable of controlling the thermal engine and the two electric machines so that torque supplied by the thermal engine is converted into energy by the two electric machines used as generators for recharging the battery after receiving a signal from the mechanism detecting the condition of the braking system indicating the braking system is activated.

The invention relates to the recharging of an electric accumulator battery used in a hybrid propulsion system for a motor vehicle.

Motor vehicles generally comprise an electrical storage element such as a battery in order to provide for the electrical requirements of the on-board equipment when the vehicle is stationary. However, because batteries are made up of capacitive elements, they are subject to leakage currents. Negligible over the short term, these leakage currents may nonetheless discharge a battery, at least partially, over lengthy periods of inactivity. In a vehicle fitted with an internal combustion engine, the battery is recharged via an alternator driven by the combustion engine. In a hybrid vehicle which is equipped with a combustion engine and with at least one electric motor, it is conceivable to use the electric motor as the generator.

Patent U.S. Pat. No. 6,637,530 describes a system for controlling the propulsion unit of a hybrid vehicle comprising a combustion engine and an electric machine capable of operating as an electric generator to recharge the battery when the combustion engine is running. This system determines the level of charge of the battery and triggers the recharging of the battery when the level of charge entails this. The electric machine can be used either in the conventional way as an alternator connected to the combustion engine or to the set of driven wheels, or as a generator under recuperative braking. The vehicle described also comprises a belt-driven continuously-variable transmission (CVT).

Patent application FR 2843339 describes a system for controlling the low-idle speed of a hybrid vehicle, in which system a combustion engine and an electric motor are operated in such a way as to achieve a low-idle speed for recharging the battery.

In all these known systems, the recharging of the battery is often too slow or insufficient given the limited quantities of electrical energy supplied by the alternator or by an electric motor operating as a generator.

Various types of vehicle can be differentiated on the basis of the nature of the storage element and of the transmission. Some vehicles comprise a low-capacity battery that allows recuperative braking and the restoration of electrical power during an acceleration phase. Other vehicles comprise a larger battery that allows purely electrical operation.

Furthermore, motor vehicles equipped with a hybrid propulsion unit with diverted power, known as an infinitely-variable transmission (IVT) with an electric variator, comprising a combustion engine and two electric motors, are known. This type of transmission has several degrees of freedom allowing finer control and affording more options in terms of modes of operation, such as the use of purely electrical modes, or switching between the various modes of operation according to the level of charge of the storage element.

A transmission of the IVT type entails the use of the two electric machines in order to be able to transmit the slightest bit of power to the wheels. A minimum level of charge is needed in order to operate them. Thus, a hybrid vehicle may have too low a charge in the storage element to be able to operate the propulsion unit, thus immobilizing the vehicle. The driver may also have need of electrical energy in order to operate on-board equipment that may consume greater or lesser amounts of energy, such as the radio, the air-conditioning, without wishing to drive along, and this when the level of charge in the storage element is approaching a critical level. Further, during prolonged periods of non-use, the storage element may empty itself.

In either scenario, a strategy for monitoring the level of charge is needed in order to control the combustion engine and use the transmission to recharge the storage element.

In order to charge the storage element, the simplest method is to mechanically decouple the engine and the wheels in order not to transmit power to the wheels. One electric machine is used as a generator, and the other is used to uncouple the wheels, ensuring that zero torque is transmitted to the wheels.

The subject of the invention is a system for controlling a hybrid propulsion unit that allows a battery used in a hybrid system with diverted power to be recharged more rapidly when the vehicle is stationary.

Another object of the invention is to provide a charging process that is entirely transparent to the driver in the case of a vehicle equipped with a decoupled brake pedal.

What is meant by a decoupled brake pedal is a brake pedal electrically connected to the actuators of the braking system as opposed to a brake pedal that is mechanically connected to the braking system.

One embodiment defines a system for controlling a hybrid propulsion unit with diverted power for a motor vehicle equipped with at least two driven wheels, comprising a combustion engine, an infinitely-variable transmission comprising at least two electric machines and at least two epicyclic gear sets, a battery, a braking system for braking the driven wheels, a means of detecting the status of the braking system, the combustion engine being mechanically connected to the infinitely-variable transmission by a first epicyclic gear set, the infinitely-variable transmission being mechanically connected to the driven wheels via a second epicyclic gear set. The control system is capable of operating the combustion engine and the two electric machines in such a way that the torque supplied by the combustion engine is converted into energy by the two electric machines which are used as generators to recharge the battery following receipt of a signal from the means that detects the status of the braking system indicating that the braking system is applied.

In other words, the control system is capable of commanding simultaneous operation of the two electric machines so that they operate as a generator such that the torque supplied by the combustion engine is converted into energy. This energy is then used to recharge the battery. During the recharging time, the wheels are locked so that no fraction of the torque is converted into kinetic energy. The charging of the battery can thus be considerably accelerated.

The control system thus defined may comprise a control means connected by its outputs to the combustion engine and to the electric machines, and by its inputs to a means of determining the charge of the battery and to the means of detecting the status of the braking system. The control means is capable of emitting torque instructions destined for the various driving components on the basis of the level of charge of the battery and the activation status of the braking system.

The control system may emit an instruction to activate the brakes so that the vehicle can be immobilized.

The control system thus defined may comprise an interface between the driver and the vehicle, which interface is connected by at least one of its inputs to the control means. The control means may emit to the interface between the driver and the vehicle a display command in order to indicate to the driver the need to activate the braking system.

Another aspect of the invention defines a method of controlling a hybrid propulsion unit with diverted power for a motor vehicle equipped with at least two driven wheels, comprising a combustion engine, an infinitely-variable transmission comprising at least two electric machines and at least two epicyclic gear sets, a battery, a braking system and a means of detecting the status of the braking system. The two electric machines are used to convert the torque supplied by the combustion engine into energy in order to recharge the battery while the braking system is activated, with the vehicle stationary.

In a control method as previously defined and comprising a control means connected by its outputs to the combustion engine and to the electric machines, and by at least one of its inputs to a means of determining the charge of the battery, it is possible to emit torque instructions destined for the various driving components on the basis of the level of charge of the battery.

It is possible automatically to command activation of the braking system while the battery is being recharged.

As an alternative, it is possible to indicate to the driver the need to activate the braking system while the battery is being recharged.

In the case of a decoupled braking system, the control system may automatically activate the braking system. However, in the case of a braking system that is not decoupled, driver intervention is required in order to activate the braking system.

The entirety of the power from the combustion engine is transmitted to the electric motors. In order to prevent them from accelerating excessively, a resistive torque instruction is emitted, allowing electrical energy to be generated.

Further objects, features and advantages of the invention will become apparent from reading the following description, given purely by way of non-limiting example and made with reference to the attached drawings in which:

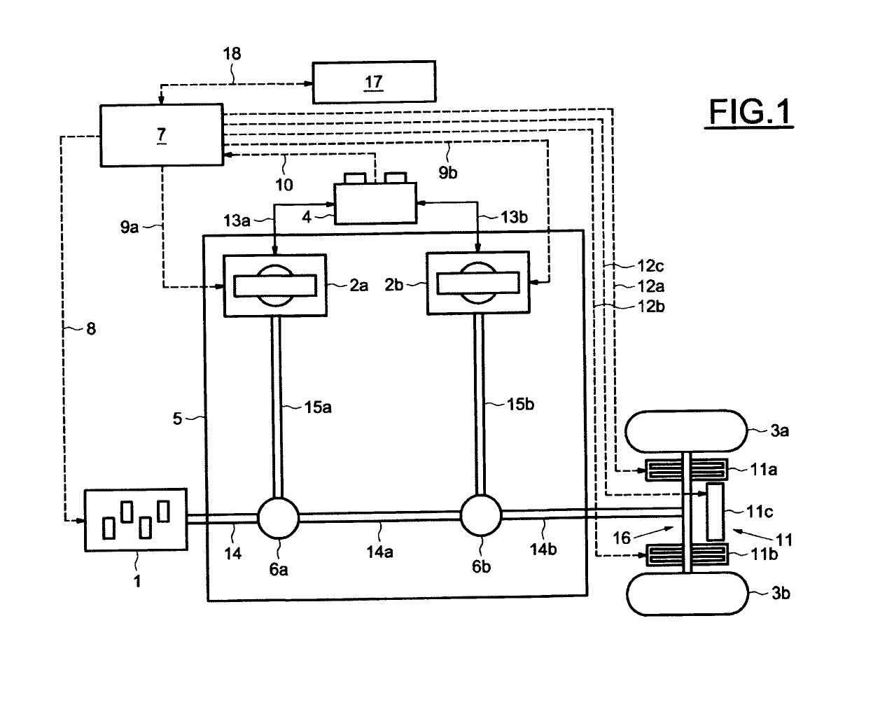

FIG. 1 shows the main components that make up a control system according to the invention;

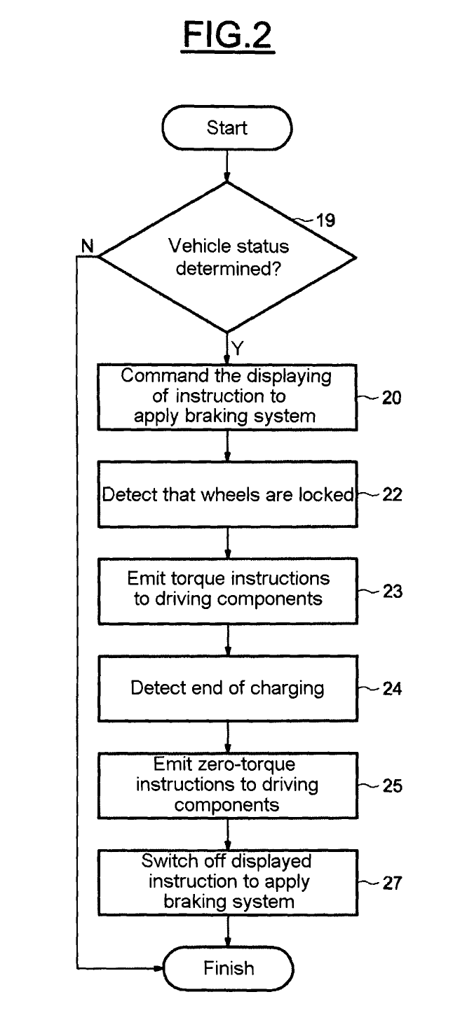

FIG. 2 shows the main steps in a control method according to one embodiment; and

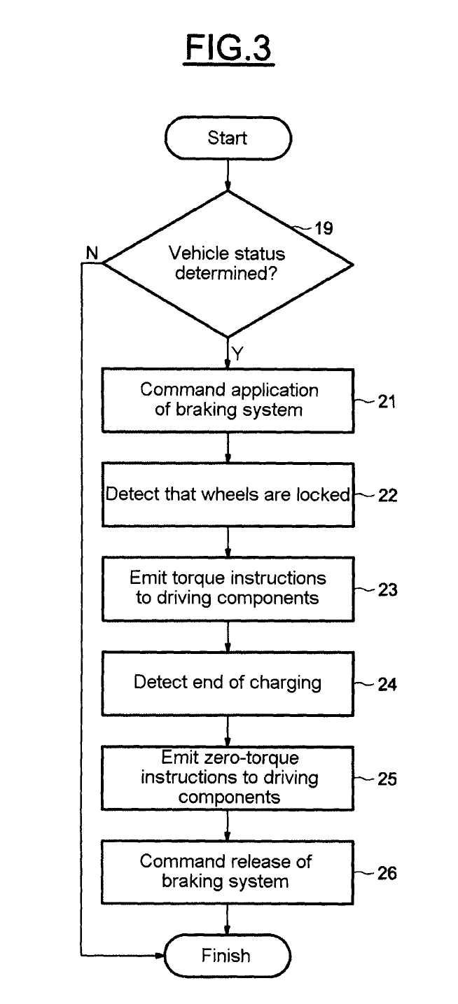

FIG. 3 shows the main steps in a control method according to another embodiment.

FIG. 1 shows the main components of a vehicle equipped with a diverted power transmission and with a propulsion unit controlled by a control system according to the invention. The vehicle comprises a combustion engine 1, driven wheels 3a and 3b, a battery 4 and an infinitely-variable transmission 5 comprising two epicyclic gear sets 6a and 6b and two electric machines 2a and 2b.

The combustion engine 1 is mechanically connected to the first epicyclic gear set 6a by the connection 14 with a view to transmitting torque. The first epicyclic gear set 6a is mechanically connected to a first electric machine 2a by the connection 15a and to the second epicyclic gear set 6b by the connection 14a. The second epicyclic gear set 6b is mechanically connected to a second electric machine 2b by the connection 15b and to the wheels 3a and 3b by a torque splitting system 16 and the mechanical connection 14b. The wheels 3a and 3b can be immobilized by a braking device 11a and 11b respectively, that makes up the braking system 11. A detection means 11c is capable of detecting the activation status of the braking system. The electric machines 2a and 2b are connected to the battery 4 by the electrical connections 13a and 13b respectively.

The infinitely-variable transmission 5 diverts and regulates the power provided by the combustion engine 1. The two electric machines 2a and 2b operate independently of one another and are able either to supply torque to supplement that supplied by the combustion engine 1, or to supply a resistive torque that is subtracted from that supplied by the combustion engine 1, the subtracted torque power being converted into electrical energy recuperatively. It is thus possible in this way to scan through a continuous range of motive power without any change to the power supplied by the combustion engine 1.

The control means 7 is connected to the combustion engine 1 by the connection 8, to the electric machine 2a by the connection 9a, to the electric machine 2b by the connection 9b, to the battery 4 by the connection 10, to the braking device 11a by the connection 12a, to the braking device 11b by the connection 12b and to the detection means 11c by the connection 12c. The control means 7 is also connected to an interface 17 between the driver and the vehicle by the connection 18 via which the driver can express his operational desire or receive information.

The control means 7 checks the level of charge of the battery 4. If the battery 4 needs to be charged, the control means 7 is capable, when the vehicle is stationary, of automatically locking the braking devices 11a and 11b if the braking system 11 is decoupled from the brake pedal. If not, the control means 7 may send a display signal to the interface 17 between the driver and the vehicle to alert the driver to the need to activate the braking system 11 when the vehicle is stationary.

As soon as the control means 7 receives confirmation that the braking system 11 has been activated and that the vehicle is stationary, it emits a torque instruction to the combustion engine 1 and resistive torque instructions to the electric machines 2a and 2b. Because the wheels are locked, all of the torque generated by the combustion engine 1 is transferred to the two electric machines 2a and 2b via the epicyclic gear sets 6a and 6b. The two electric machines 2a and 2b simultaneously operate as generators and the torque generated is converted into energy which is used to recharge the battery 4.

The control means 7 is able to monitor the charging of the battery 4 and to interrupt the operation when the battery 4 has been sufficiently recharged. To do this, the control means 7 emits zero-torque instructions to the combustion engine 1 and to the electric machines 2a and 2b, then deactivates the braking system 11 in the case of a decoupled braking system 11 or sends an instruction to switch off the display signal at the interface 17 between the driver and the vehicle to alert the driver to the possibility of deactivating the braking system 11.

FIG. 2 shows the main steps in a control method for a braking system that is not decoupled. Step 19 determines whether the battery 4 needs to be charged and whether the vehicle is stationary. In the affirmative, the method proceeds to step 20, otherwise the method ends. Step 20 commands the displaying of an instruction to activate the braking system 11, which instruction is visible to the driver. Step 22 checks that the wheels are indeed locked. The method then passes on to step 23 during which torque instructions are emitted to the electric machines 2a and 2b and to the combustion engine 1. When an end-of-charging status is detected in step 24, the method proceeds to step 25 during which zero-torque instructions are emitted to the combustion engine 1 and to the electric machines 2a and 2b. Step 27 commands the switching-off of the displayed instruction to activate the brakes.

FIG. 3 shows another embodiment for the case of a braking system decoupled from the brake pedal.

Steps that are identical to those described in FIG. 2 have the same numbering.

Step 19 determines whether the battery 4 needs to be charged and whether the vehicle is stationary. In the affirmative, the method proceeds to step 21, otherwise the method ends. In step 21 the wheels are locked by automatically commanding activation of the braking system 11. Step 22 checks that the wheels are indeed locked. The method then moves on to step 23 during which torque instructions are emitted to the electric machines 2a and 2b and to the combustion engine 1. When an end-of-charging status is detected in step 24, the method moves on to step 25 during which zero-torque instructions are emitted to the combustion engine 1 and to the electric machines 2a and 2b. Step 26 commands deactivation of the braking system 11.

The invention proposes a simple and effective way of quickly recharging a battery in a hybrid vehicle equipped with an infinitely-variable transmission with electric variator. By dispensing with the need to uncouple the wheels using one electric machine, the system is able to use two electric machines simultaneously instead of just one, and to recharge a battery more rapidly. The cost in terms of fuel is lower by comparison with conventional solutions and does not require the vehicle to be moving.

In the case of a decoupled braking system, the locking of the wheels and the recharging of the storage element are performed in a way that is transparent to the driver.

1-8. (canceled)

9. A system for controlling a hybrid propulsion unit with diverted power for a motor vehicle including at least two driven wheels, comprising:
a combustion engine;
a battery;
a braking system that brakes the driven wheels;
means for detecting a status of the braking system; and
an infinitely-variable transmission comprising at least two electric machines and at least two epicyclic gear sets, the combustion engine being mechanically connected to the infinitely-variable transmission by a first epicyclic gear set, the infinitely-variable transmission being mechanically connected to the driven wheels via a second epicyclic gear set,
wherein the control system is capable of operating the combustion engine and the two electric machines such that torque supplied by the combustion engine is converted into energy by the two electric machines that are used as generators to recharge the battery following receipt of a signal from the means for detecting the status of the braking system indicating the braking system is activated.

10. The control system as claimed in claim 9, further comprising control means connected by its outputs to the combustion engine and to the electric machines, and by its inputs to a means for determining a charge of the battery and to the means for detecting the status of the braking system, the control means for emitting torque instructions destined for driving components on the basis of a level of charge of the battery and an activation status of the braking system.

11. The control system as claimed in claim 10, in which the control means is connected by at least one of its outputs to the braking system of the vehicle, the control system being capable of emitting an instruction to activate the braking system.

12. The control system as claimed in claim 10, further comprising an interface between the driver and the vehicle, which interface is connected by at least one of its inputs to the control means, the control means further for emitting to the interface between the driver and the vehicle a display command to indicate to the driver a need to activate the braking system.

13. A method of controlling a hybrid propulsion unit with diverted power for a motor vehicle including at least two driven wheels, including a combustion engine, a battery, a braking system, and an infinitely-variable transmission including at least two electric machines and at least two epicyclic gear sets, the method comprising:
simultaneously using the two electric machines to convert torque supplied by the combustion engine into energy to recharge the battery while the braking system is activated.

14. The control method as claimed in claim 13, in which torque instructions destined for the driving components are emitted on the basis of a level of charge of the battery and of an activation status of the braking system.

15. The control method as claimed in claim 13, in which activation of the braking system while the battery is being recharged is commanded.

16. The control method as claimed in claim 13, in which a need to activate the braking system while the battery is being recharged is indicated to the driver.
